(19) United States
(12) Patent Application Publication
(10) Pub. No.: US 2026/0257514 A1
(43) Pub. Date: Sep. 3, 2026

(54) HUB SEALING CAP WITH MECHANICALLY RETAINED VIEWING WINDOW

(71) Applicant: RevHD LLC, LaVergne, TN (US)

(72) Inventor: Daylen Borders, LaVergne, TN (US)

(21) Appl. No.: 19/358,356

(22) Filed: Oct. 14, 2025

Related U.S. Application Data
(60) Provisional application No. 63/765,936, filed on Mar. 3, 2025.

(51) Int. Cl. B60B 7/00; B60B 27/00

(52) U.S. Cl. CPC B60B 7/0013; B60B 27/0073

(57) ABSTRACT

The present disclosure provides hub sealing caps. In some embodiments, the hub sealing cap comprises a viewing window that is located in an interior of a hubcap body. The viewing window may have a front end and rear end and may be retained on the rear end by a viewing window retaining ring, which may be positioned in a groove located in the interior of the hubcap body. The viewing window front end may include a gland/ledge/flange/groove that holds a sealing ring. The hub sealing cap may also include a circular front end with a centrally-located circular aperture, and a vent cap may be positioned in the circular aperture of the circular front end and an aligned circular aperture centrally-located in the viewing window.

### BACKGROUND

### Technical Field

The present invention relates to hub sealing caps for trucks, buses and tractor trailers.

### Background of the Invention

Trucks, buses, and tractor/trailer non-driven axle hubs are commonly equipped with a sealing cap on the outboard side to contain wheel bearing lubricant and protect the inner workings of the hub from external contamination.

Most prior art designs typically feature a plurality of components to retain and seal a viewing window into a cylindrical body assembly featuring a mounting flange or thread to mate to a hub.

These designs typically require multiple fasteners, a clamping component, and one or more sealing elements to complete the assembly of the hub sealing cap resulting in a complex and failure-prone method of manufacturing of the same.

Thus, there is a need for new hub sealing cap designs.

### SUMMARY OF THE INVENTION

The present invention relates to hub sealing caps. Optionally, the hub sealing cap includes a viewing window that is retained on the oil-side of the viewing window as described below.

### BRIEF DESCRIPTION OF THE DRAWINGS

FIG. 1 illustrates a front perspective view of a hub sealing cap of one embodiment of the present invention.

FIG. 2 illustrates side elevation view of the hub sealing cap of FIG. 1.

FIG. 3 illustrates a rear perspective view of the hub sealing cap of FIG. 1.

FIG. 4 illustrates a rear plan view of the hub sealing cap of FIG. 1.

FIG. 5 illustrates a front plan view of the hub sealing cap of FIG. 1.

FIG. 6 illustrates a front sectional view of the hub sealing cap of FIG. 5, taken along line 6-6 of FIG. 5.

FIG. 7 illustrates a side, exploded perspective view of the hub sealing cap of FIG. 1.

FIG. 8 illustrates a rear, exploded perspective view of the hub sealing cap of FIG. 1.

FIG. 9 illustrates a side perspective view of a hub sealing cap of another embodiment of the present invention.

FIG. 10 illustrates a front plan view of the hub sealing cap of FIG. 9.

FIG. 11 illustrates a side elevation view of the hub sealing cap of FIG. 9.

FIG. 12 illustrates a side elevation view of the hub sealing cap of FIG. 9.

FIG. 13 illustrates a sectional view of the hub sealing cap of FIG. 12, taken along line 13-13 of FIG. 12.

FIG. 14 illustrates a side elevation view of the hub sealing cap of FIG. 9.

FIG. 15 illustrates a sectional view of the hub sealing cap of FIG. 14, taken along line 15-15 of FIG. 14.

FIG. 16 illustrates a side, exploded perspective view of the hub sealing cap of FIG. 9.

FIG. 17 illustrates a rear, exploded perspective view of the hub sealing cap of FIG. 9.

FIG. 18 illustrates a rear, exploded perspective view of the viewing window and hubcap body of the hub sealing cap of FIG. 9.

FIG. 19 illustrates a side, exploded perspective view of assembly of a hub sealing cap of one embodiment of the present invention using a fixture.

FIG. 20 illustrates a sectional view of the hub sealing cap and fixture of FIG. 19, taken along line 20-20 of FIG. 19.

FIG. 21 illustrates a side perspective view of a hub sealing cap of another embodiment of the present invention.

### DETAILED DESCRIPTION

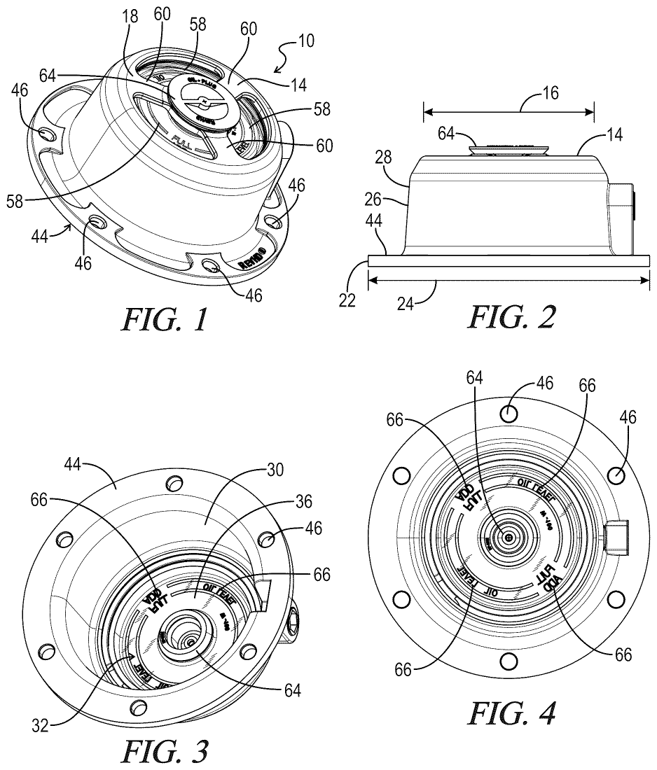

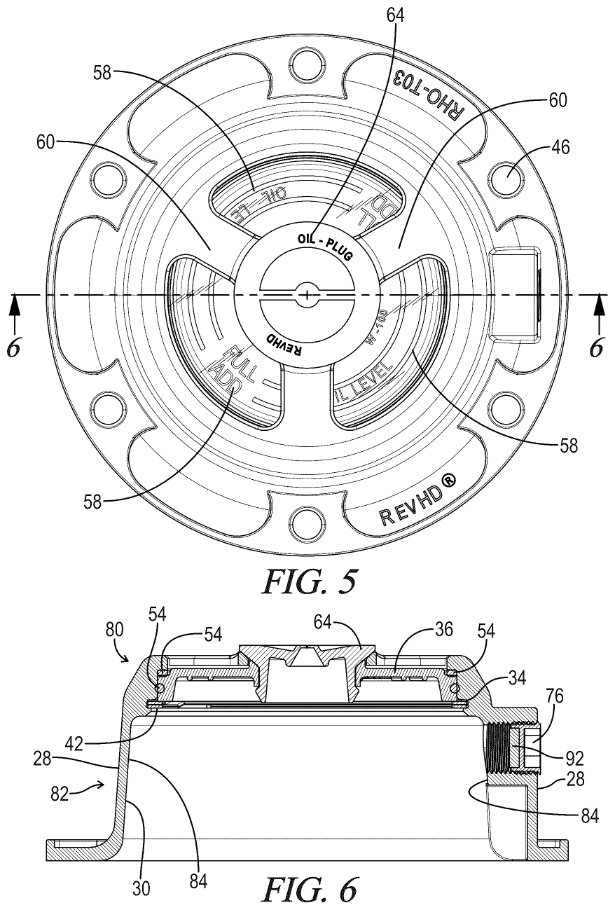

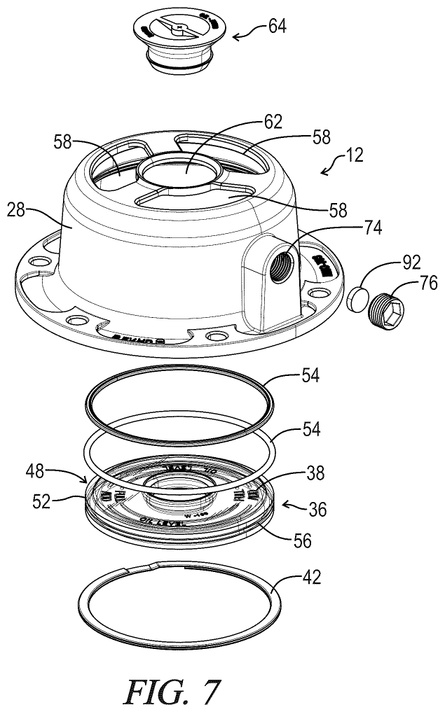

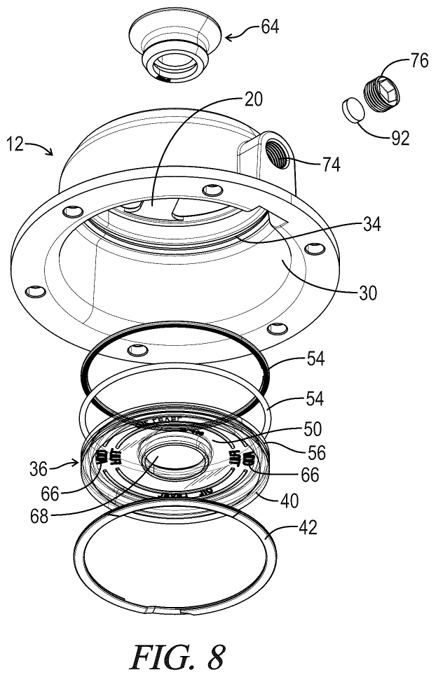

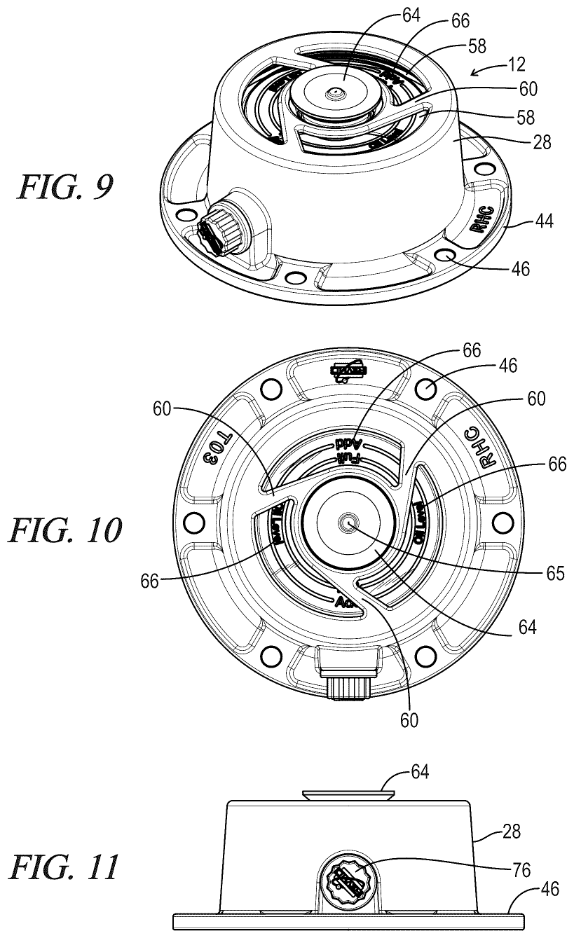

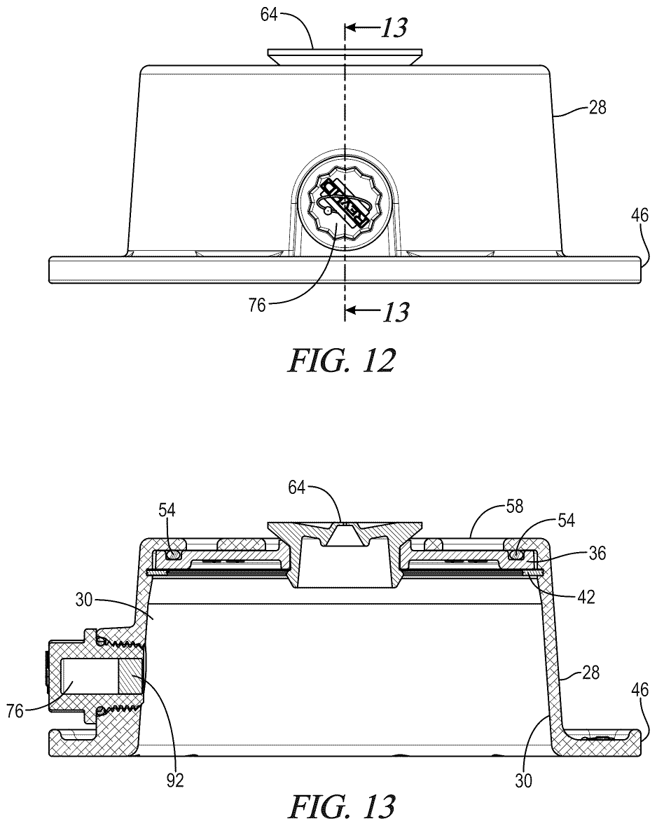

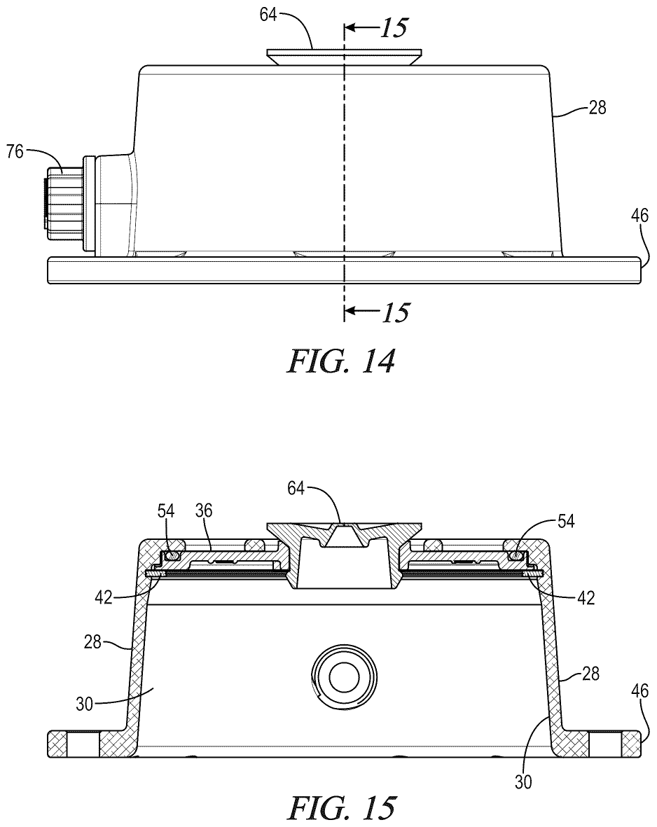

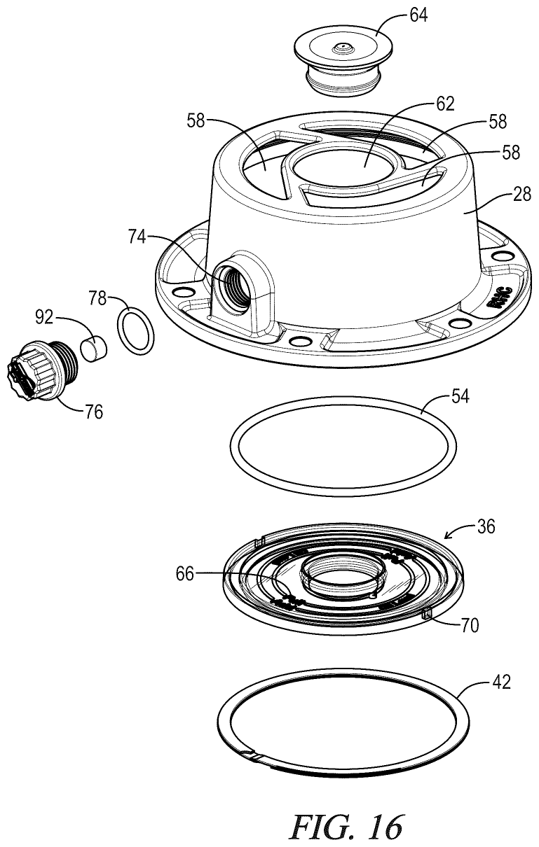

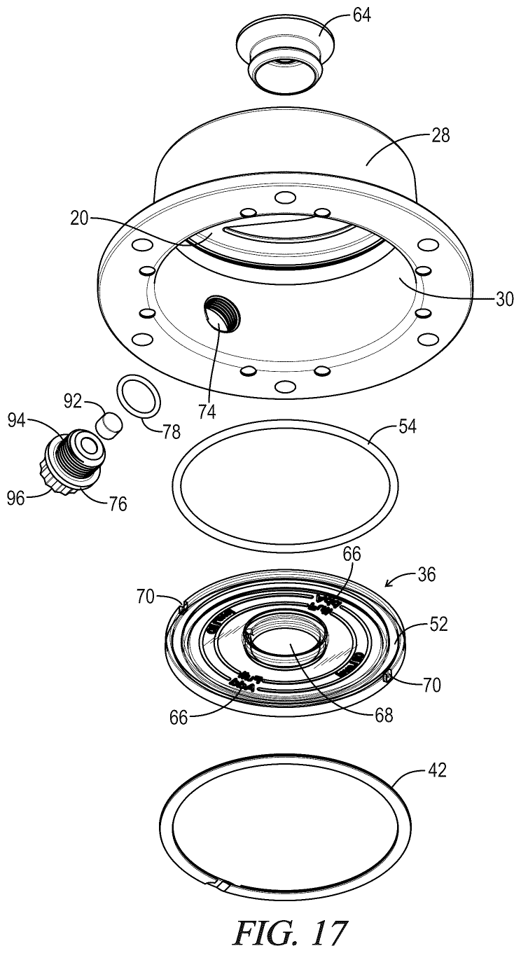

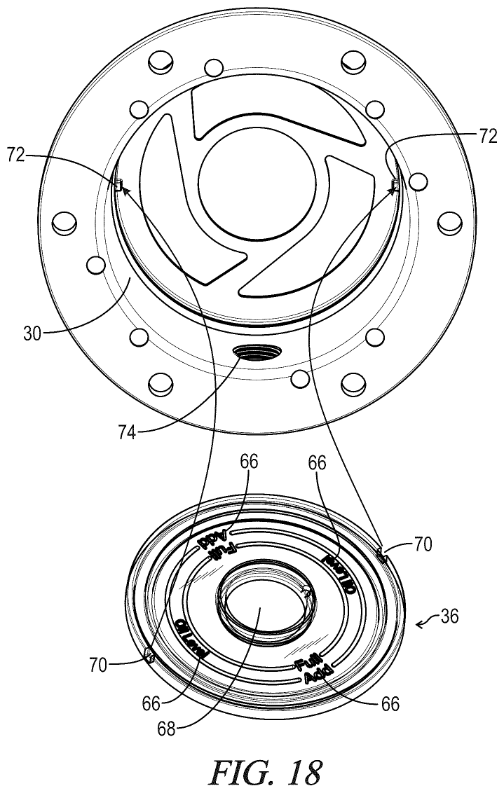

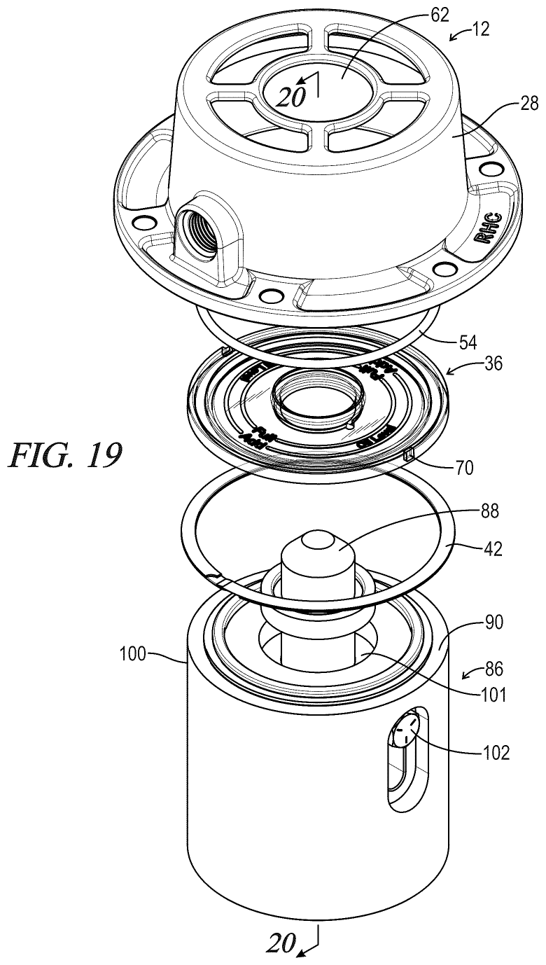

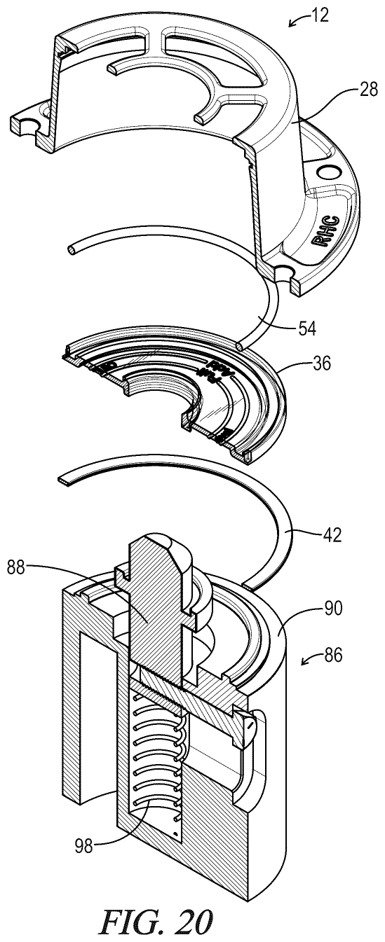

With reference to FIGS. 1-21, the present disclosure provides a hub sealing cap, generally designated by the numeral 10. In the drawings, not all reference numbers are included in each of the drawings for the sake of clarity. FIGS. 1-21 are CAD drawings drawn to scale, however, it will be appreciated that other dimensions are possible. It will be appreciated that the hub sealing cap 10 may assume different orientations in use.

Referring further to FIGS. 1-21, in some embodiments, the present disclosure provides a hub sealing cap 10. The hub sealing cap 10 may include a hubcap body 12 (sometimes referred to herein as body) that may be cylindrical and may include a front end 14 that may be circular and may comprise a diameter 16 and optionally one or more apertures 58, a rear end 22 that may be circular and may include a diameter 24, and a sidewall 26 located between the front end 14 and the rear end 22 that may enclose an interior 32 that may be hollow. The sidewall 26 may include a sidewall interior face 30 and a sidewall exterior face 28. The sidewall interior face 30 may face the hollow interior 32 and may comprise a sidewall groove 34 extending circularly (about an inner circumference of the sidewall interior face 30) about the hollow interior 32. The hubcap body circular front end 14 may comprise a front face 18 and a rear face 20 facing the hollow interior 32.

Optionally, the circular rear end 22 of the hubcap body 12 is in the form of either a threaded hub mounting feature (not shown) or a hub mounting flange 44 (shown in FIGS. 1-21) located to the rear of the hubcap body sidewall 26 with the flange 44 comprising a plurality of fastener apertures 46 spaced about a circumference of the flange 44. Optionally, the rear end 22 of the hubcap body 12 has a diameter 24 that is greater than the diameter 16 of the circular front end 14 of the hubcap body 12.

The hubcap body 12 may be comprised of, for example, metal or polymer materials. The hubcap body 12, as is known in the art and not shown, may include with a mounting flange or thread for assembly onto common wheel hubs with a gasket around the diameter and between the mounting flange or thread of the sealing cap and the mating hub.

The hub sealing cap 10 may also include a viewing window 36, which may be cylindrical, may be located in the hollow interior 32, may confront the sidewall interior face 30 and/or the rear face 20 of the hubcap body circular front end 14. The viewing window 36 may comprise a circular front end 38 that may be located to the rear of (and adjacent to) the rear face 18 of the circular front end 14 of the hubcap body 12, and a circular rear end 40. The front end 38 of the viewing window 36 may comprise a gland/ledge/flange/groove 52 that holds a seal/gasket 54, as described below. Optionally, the front end 38 of the viewing window 36 comprises a front face 48 that confronts the rear face 20 of the hubcap body circular front end 14, and optionally the gland/ledge/flange/groove 52 is located on the front face 38.

The viewing window 36 may be clear or translucent to allow a user to visualize oil or other lubricant located in the hollow interior 32 located to the rear of the viewing window rear end 40. Optionally, the viewing window 36 comprises one or more indicia 66 that provide feedback to the user on the lubricant level. Optionally, the indicia 66 are located on the front 48 or rear face 50 of the viewing window 36. The indicia 66 may include one or more integral markings printed, stamped, molded, or formed into the face to communicate minimum, maximum, or nominal lubricant fill levels for proper hub wheel bearing operation and performance life. The indicia 66 may be located on the oil (rear end 40) of the viewing window 36 with three-dimensional geometry such that the markings have a concavity that reflects light outward at the viewer to enhance the visibility of the markings in low-light conditions. Alternatively, viewing window indicia 66 may incorporate reflective inks, materials, or photoreactive pigments to provide enhanced viewability in low-light conditions.

The hub sealing cap 10 may also include one or more gaskets/seals 54 located between the cylindrical viewing window 36 and the hubcap body 12 that creates a seal between the cylindrical viewing window 36 and the hubcap body 12. In some embodiments, the gasket 54 creates an axial seal. For example, optionally, the gasket 54 is seated in the gland/ledge/flange/groove 52, may confront the sidewall interior face 30 and/or the rear face 20 of the circular front end 14 of the hubcap body 12, and may be located forwardly relative to the sidewall groove 34. In addition to or in lieu of a gasket 54 creating an axial seal, the hub sealing cap 10 may include a gasket 54 that creates a radial seal. For example, the gasket 54 may extend about a circumference of the cylindrical viewing window 36 (to create a seal in the radial direction). More particularly, the cylindrical viewing window 36 may comprise a viewing window groove 56 located between the window circular front end 38 and the window circular rear end 40 and extending about a circumference of the cylindrical viewing window 36 and the gasket 54 may be seated in the viewing window groove 56. The gasket 54 may be any suitable shape and may be an O-ring or quad ring, for example. For example, FIGS. 6-8 show two gaskets 54: a first gasket 54 that creates an axial seal and a second gasket 54 that creates a radial seal Optionally, the gasket 54 is comprised of an elastomeric polymer of a vulcanized rubber (e.g., nitrile butadiene rubber (NBR) or hydrogenated nitrile butadiene rubber (HNBR) or a thermoplastic elastomer compound. Preferably, if the gasket 54 is used to create an axial seal, optimal clamp loading of the gasket 54 in the gland/ledge/flange groove 52 ensures the seal is maintained through the full operating temperature extremes and exposure of the hub sealing cap 10 for its design life on a wheel hub on common truck, bus, or tractor/trailer vehicles across all regions of the globe.

The hub sealing cap 10 may also include a viewing window retaining ring 42 that may be located to the rear of the rear face 20 of the circular front end 14 and optionally to the rear of the circular rear end 40 of the cylindrical viewing window 36. The viewing window retaining ring 42 may confront the cylindrical viewing window 36 (preferably the circular rear end 40 of the cylindrical viewing window 36) and the sidewall interior face 30. Optionally, the viewing window retaining ring 42 is seated in the sidewall groove 34 and holds the viewing window 36 in place—i.e., prevents the cylindrical viewing window 36 from moving rearwardly in the hollow interior 32.

Optionally, the viewing window retaining ring 42 is configured to change diameter when compressed radially. For example, in the relaxed state, the viewing window retaining ring 42 may be partially circular and/or comprise one or more rings overlapping in a spiral fashion so that it has a break in continuity to allow the viewing window retaining ring 42 to change in diameter when compressed radially. As known to those of ordinary skill and described in U.S. Pat. No. 8,905,698, the contents of which are incorporated herein by reference, a retaining ring is a device which fits in a groove on a shaft or bore to locate one or more other components relative to the shaft or bore. An external retaining ring is typically disposed in a groove on an outer surface of a shaft, and an internal retaining ring is typically disposed in a groove on an inner surface of a bore or housing. Since the viewing window retaining ring 42 described herein is typically used in the interior 32 of the hubcap body 12, it would be referred to as an internal retaining ring. Retaining rings typically provide either complete or incomplete coverage of the 360 degree groove surface. Examples of known incomplete retaining rings include “snap rings” (also known as “circlips”), “e-rings” and “crescent rings”. Examples of known complete retaining rings include “spiral rings” such as the SPIROLOX retaining ring produced by Smalley Ring Steel Company. Spiral retaining rings are typically formed by coiling a flat wire to form a 2-turn or 3-turn spiral. Retaining rings are in wide usage across a variety of industries including aerospace, automotive, mining and drilling. The viewing window retaining ring 42 may be any retaining ring that is currently in use or later developed.

Optionally, the viewing window retaining ring 42 is manufactured from metallic material (preferably stainless steel) or polymeric material (e.g., a polyamide, a polyether ether ketone, a polybutylene terephthalate, or a polyethylene terephthalate). Preferably, as described above, the viewing window retaining ring 42 has a spring memory integrally configured into the material such that the viewing window retaining ring 42 compresses radially to a smaller diameter during assembly (as the viewing window retaining ring 42 is moved forwardly through the hubcap body interior 32—e.g., along sidewall exterior face 30) and then returns to its relaxed state (nominal as-manufactured diameter) when entering the sidewall groove 34.

Optionally, the viewing window retaining ring 42 and the sidewall groove 34 each comprise a circumference and the circumferences of the sidewall groove 34 and the viewing window retaining ring 42 (in the relaxed state) are substantially equal so that the viewing window ring 42 is interference fit in the sidewall groove 34. The diameters can be configured for a slight clearance or interference depending on application. More particularly, optionally, the cone geometry of the hubcap body sidewall interior face 30 tapers in decreasing diameter—i.e., from a larger clearance diameter relative to the diameter of the viewing window retaining ring 42 (in the relaxed state) to a smaller diameter than the diameter of the viewing window retaining ring 42 (in the related state). Optionally, as the viewing window retaining ring 42 is pressed axially into the cone geometry of the hubcap body sidewall 26, the viewing window retaining ring 42 is compressed into a gradually smaller diameter until it reaches the sidewall groove 34. Optionally, the sidewall groove 34 is cut, formed, or molded into the sidewall interior face 30 of the hubcap body 12.

The viewing window retaining ring 42 may also feature tabs, slots, holes, or angled cuts to allow it to be manually compressed with tools for assembly or disassembly.

The viewing window retaining ring 42 may also be designed such that in its installed state, it is tamper-resistant to prevent removal or disassembly of the viewing window 36 that it is retaining in the hubcap assembly thereby protecting the design from failure induced by an untrained technician.

The sidewall groove 34 may also feature an inside diameter sufficient to prevent the viewing window retaining ring 42 from bowing in an axial direction when acted on by the viewing window 36 as the viewing window 36 is compressed against the static face seal between the gasket/seal 54 and the rear face 20 of the hubcap body circular front end 14.

The axial placement of the sidewall groove 34 may be configured such that when the viewing window retaining ring 42 is pressed into the hollow interior 32 of the hubcap body 12 and snapped into the sidewall groove 34 during the assembly process, it sets the optimal clamp load of the viewing window static seal described above while simultaneously serving to retain the viewing window 36 into the hub sealing cap assembly, accounting for tolerances with manufacturing variation in the viewing window thickness, the gland/ledge/recess/flange 52 depth, and the gasket 54 itself.

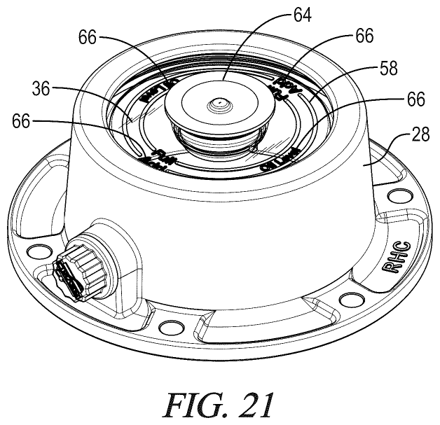

As shown in FIGS. 1-20, the hubcap body circular front end 14 may also include a plurality of spokes/ribs 60 molded, formed, or machined designed to protect the viewing window 36 from damage caused by impact or abuse in the application, and such a plurality of spokes/ribs may create a plurality of apertures 58. These spokes or ribs 60 can be configured to provide aesthetic value and may also provide integral mounting features to allow external components to be assembled onto the hubcap assembly such as hub odometers, tire pressure monitoring or inflation system components, or other wheel components as needed. The ribs/spokes 60 may create a plurality of radial apertures 58 that may be, for example, spaced asymmetrically or symmetrically, or spaced radially from a central, circular aperture 62, etc. Alternatively, as shown in FIG. 21, in lieu of ribs/spokes, the circular front end 14 of the hubcap body 12 may include one aperture 58.

Optionally, the hubcap body 12 and the cylindrical viewing window 36 are keyed/comprise a mating protrusion 72 and recess 70 to ensure the cylindrical viewing window 36 are aligned (e.g., so that the indicia 66 are not blocked by a spoke 60). For example, the hubcap body 12 may include either a singular or a plurality of male protrusions 72 either on the interior face 30 of the sidewall 26 or the rear face 20 of the hubcap front end 14 designed to mate into corresponding female slots, holes, flats or other recesses 70 made into the outer diameter of the viewing window 36 in a manner to provide alignment of the viewing window indica 66 in a prescribed fashion so the indicia 66 are not blocked by spokes/ribs 60 that may be located in the circular front end 14 of the hubcap body 12.

Optionally, the circular front end 14 of the hubcap body 12 has a greater diameter than the diameter of the cylindrical viewing window 36.

Optionally, the sidewall 26 of the hubcap body 10 comprises a fill hole 74 removably receiving a fill plug 76 to allow oil to be filled into the hollow interior 32 of the hubcap body 12. Optionally, the fill plug 76 is attached to the fill hole 74 via threads 94. Optionally, the viewing window retaining ring 42 is located forwardly relative to the fill hole 74. Optionally, the fill plug 76 comprises an O-ring. 78. Optionally, the fill plug 76 comprises a shaft with threads 94 and a head 96 that is configured to be tightened by a socket (e.g., hex shape) and/or configured to be tightened by hand (e.g., comprises knurling).

Optionally, the sidewall 26 of the hubcap body 12 is not continuous and is comprised of a front segment 80 and a rear segment 82. Optionally, the front segment 80 is indented relative to the rear segment 82. Optionally, the sidewall groove 34 is located in the front segment 80.

Optionally, the hub sealing cap 10 is located on a vehicle.

Optionally, the viewing window 36 comprises a central, circular aperture 68 located approximately in the center of the viewing window 36. Optionally, a plug 64 (which may include one or more vent apertures 65, e.g., slit(s) or hole(s)) is positioned in the central aperture 68 of the window ring circular front end and 38. Optionally, the circular front end 14 of the hubcap body 12 comprises a central aperture 62 located approximately in a center of the circular front end 14 aligned with the viewing window central aperture 68 and the plug 64 is also positioned in the central aperture 62 of the circular front end 14 so that the plug 64 extends from in front of the circular front end 14 to the rear of the cylindrical viewing window rear end 40. Optionally, the plug 64 is chamfered to make it easier to install and remove.

### Exemplary Method of Manufacture

An exemplary method of manufacture/assembly is described below. It will be understood that the method is merely exemplary.

First, the viewing window retaining ring 42, the viewing window 36, and the gasket 54 (the “hubcap components”) may be stacked on a fixture 86 designed to accept and pre-align these components prior to assembly. In particular, a metallic or polymeric fixture 86 as above, machined, or additive printed to include a base 100 with a raised, machined, or formed diameter (e.g., groove 90) designed to initially center the viewing window retaining ring 42 and to support the ring 42 axially. The groove 90 may be designed with diametral clearance to allow the viewing window retaining ring 42 to be radially compressed and centered progressively in the hubcap body interior 32 during the hubcap assembly process.

The fixture base 100 may also include an axial clearance hole 101 machined or formed to accept a spring-loaded, machined, or formed metallic or polymeric post 88 on its center axis. The fixture base 100 may have a horizontal slot with clearance machined or formed into its side to accept a screw 102 threaded into the side of the spring-loaded post 88. The spring 98 and the screw 102 may control movement of the post 88 up and down in the fixture 86. The screw 102 may follow in the slot, and the post 88 may translate axially in the center clearance hole 101 described above. The spring 98 may be a compression-type placed under the post 88 in the clearance hole 101 and may hold the post 88 axially at the top of its stroke limited by a screw 102 and a slot described below. The post 88 may be fixed by the screw 102 to also limit axial travel so that the post 88 is retained in the fixture base 100 at the top of its stroke. This position is the “home” position of the fixture assembly. The post 88 may have its length set to allow the stack of hubcap components to be compressed fully to allow engagement of the viewing window retaining ring 42 in its mating groove 34 on the sidewall interior face 30 of the hubcap body 12. The post 88 may have a clearance at its bottom inside the fixture base 100 so that the limit of travel during assembly is controlled by the fixture base 100 and the full compression of the gasket 54 in its gland/ledge/recess/flange 52 with the viewing window 36 mating against the rear face 20 of the front end 14 of the hubcap body 12. The screw 102 may also serve to prevent rotation of the post 88 in the fixture base 100 to maintain alignment of all hubcap components during assembly. The post 88 may feature a tapered end to allow the central aperture 68 in the viewing window 36 to be guided over it during staging of the components. The post 88 may have a machined or formed ring to support and center the viewing window 36 before assembly.

The post 88 may be keyed to the cylindrical viewing window 36 (e.g., the top and/or post 88 of the fixture 86 may include a groove configured to hold the gasket and/or a protrusion configured to mate with the rear 40 of the cylindrical viewing window 36). For example, the fixture 86 may have a slot, hole, or tab machined or formed into the fixture 86 to accept a mating tab, pin, or flat molded onto the viewing window 36 so that the viewing window 36 may be aligned relative to the hubcap body 12 during assembly. Alignment allows the oil level indicia 66 on the viewing window 36 to be more viewable in the final assembly. The base 100 of the fixture 86 may feature a plurality of alignment pins designed to interface into the fastener apertures 46 on the hubcap body 12 and/or a machined slot which mates with the side fill plug 76 on the hubcap body 12. These elements combine to provide alignment of the hubcap body 12 relative to the viewing window 36 which is limited to a specific placement orientation in the fixture 86 by the above-mentioned mating of the slot and tab on the post 88 and viewing window 36.

The hubcap body 12 may also be keyed to the viewing window 36, as described above, to permanently control the alignment of the viewing window indicia 66 relative to the hubcap body 12 (in particular the spokes 60) after assembly.

As the hubcap body 12 is pressed down onto the fixture 86 axially, it too may be centered by the post 88 which facilitates and guides the component stack together axially and radially.

Optionally, continued pressing of the component stack eventually allows the gasket(s) 54 to be axially compressed between the viewing window gland/ledge/recess/groove 52 and the rear face 20 of the hubcap body front end 14 while simultaneously squeezing or reducing the diameter of the viewing window retaining ring 42 radially as it interfaces and slides axially on the tapering segment 84 of the sidewall interior face 30.

The tapering segment 84 may have its angle set relative to the axis of movement such that the viewing window retaining ring 42 can be compressed with minimal force and so that it can slide axially along the sidewall interior face 30.

The surface finish of the sidewall interior face 30 may be sufficiently smooth to allow sliding of the viewing window retaining ring 42 and is preferably free of defects that might hinder or interrupt movement of the viewing window retaining ring 42 along the sidewall interior face 30.

Once the component stack achieves a preset distance, the viewing window retaining ring 42 may encounter the sidewall groove 34 machined, molded, or formed into the interior face 30 of the sidewall 26 designed to accept the thickness of the viewing window retaining ring 42 with clearance. The distance may be set to provide sufficient compression of the gasket 54 in its gland/ledge/groove/recess 52 accounting for tolerances with manufacturing variation. At that distance, the viewing window retaining ring 42 may be no longer constrained radially by the inclined sidewall interior face 30 thereby allowing the radial spring force of the viewing window retaining ring 42 to expand axially outward to its free state into the sidewall groove 34 to complete the assembly.

Removal of the press load may allow the spring-loaded post 88 to return to its first state or home position and off the alignment pins in the base 100.

The plug 64 may be added to the center aperture 62 at any stage in assembly or may be provided loose in the product packaging for the customer to attach to the center aperture 62.

This operation may complete the hubcap assembly. The completed assembly can then be removed from the fixture 86 and moved to additional assembly processes or packaging.

All operations of the assembly process can be accomplished manually or by machine placement and automation.

Parts List

| | |
|---|---|
| hub sealing cap | 10 |
| hubcap body | 12 |
| body front end | 14 |
| body front end diameter | 16 |
| front end front face | 18 |
| front end rear face | 20 |
| body rear end | 22 |
| body rear end diameter | 24 |
| sidewall | 26 |
| sidewall exterior face | 28 |
| sidewall interior face | 30 |
| hollow interior | 32 |
| sidewall groove | 34 |
| viewing window | 36 |
| window front end | 38 |
| window rear end | 40 |
| retaining ring | 42 |
| flange | 44 |
| fastener apertures | 46 |
| window front end front face | 48 |
| window front end rear face | 50 |
| gland/ledge/flange/groove | 52 |
| sealing ring/gasket | 54 |
| viewing window groove | 56 |
| body front end apertures | 58 |
| body front end spokes | 60 |
| body circular aperture | 62 |
| plug | 64 |
| plug slit | 65 |
| indicia | 66 |
| viewing window central aperture | 68 |
| viewing window recess | 70 |
| hubcap body protrusion | 72 |
| fill hole | 74 |
| fill plug | 76 |
| fill plug o-ring | 78 |
| front segment | 80 |
| rear segment | 82 |
| tapering segment of sidewall | 84 |
| fixture | 86 |
| spring-loaded post | 88 |
| fixture groove | 90 |
| magnet | 92 |
| fill plug threads | 94 |
| fill plug head | 96 |
| spring | 98 |
| Fixture base | 100 |
| Hole | 101 |
| Screw | 102 |

Having now described the invention in accordance with the requirements of the patent statutes, those skilled in the art will understand how to make changes and modifications to the disclosed embodiments to meet their specific requirements or conditions. Changes and modifications may be made without departing from the scope and spirit of the invention. In addition, the steps of any method described herein may be performed in any suitable order and steps may be performed simultaneously if needed. Use of the singular embraces the plural.

Terms of degree such as “generally”, “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

What is claimed is:

1. A hub sealing cap comprising:
a cylindrical hubcap body comprising a circular front end comprising a diameter, a front face and a rear face, a circular rear end, and a sidewall located between the circular front end and the circular rear end, the sidewall comprising a sidewall interior face and a sidewall exterior face and enclosing a hollow interior, the sidewall interior face facing the hollow interior and comprising a sidewall groove extending circularly about the hollow interior;
a cylindrical viewing window located in the hollow interior, confronting the sidewall interior face, the cylindrical viewing window being clear or translucent, the cylindrical viewing window comprising a circular front end and a circular rear end; and
a viewing window retaining ring located to the rear of the cylindrical viewing window and confronting the cylindrical viewing window and the sidewall interior face, the viewing window retaining ring seated in the sidewall groove and preventing the cylindrical viewing window from moving rearwardly in the hollow interior.

2. The hub sealing cap of claim 1 wherein the viewing window retaining ring is located to the rear of and confronting the circular rear end of the cylindrical viewing window.

3. The hub sealing cap of claim 1 wherein the viewing window retaining ring is configured to change diameter when compressed radially.

4. The hub sealing cap of claim 3 wherein the viewing window retaining ring is partially circular or comprises one or more rings overlapping in a spiral fashion.

5. The hub sealing cap of claim 1 wherein the viewing window retaining ring and the sidewall groove each comprise a circumference and further wherein the circumferences of the sidewall groove and the viewing window retaining ring are substantially equal.

6. The hub sealing cap of claim 1 wherein the circular rear end is substantially open and leads to the hollow interior.

7. The hub sealing cap of claim 1 further comprising a gasket located between the cylindrical viewing window and the hubcap body.

8. The hub sealing cap of claim 7 wherein the gasket is in the form of an O-ring or quad ring creating a seal between the cylindrical viewing window and the hubcap body.

9. The hub sealing cap of claim 1 wherein the cylindrical viewing window comprises a circular front end comprising a front face comprising a gland, and further wherein the gasket is seated in the gland, confronting the sidewall interior face, and located forwardly relative to the sidewall groove.

10. The hub sealing cap of claim 7 wherein the rear face of the circular front end of the hubcap body faces the hollow interior and further wherein the gasket confronts the rear face of the circular front end of the hubcap body to create a seal in the axial direction.

11. The hub sealing cap of claim 7 wherein the gasket extends about a circumference of the cylindrical viewing window to create a seal in the radial direction.

12. The hub sealing cap of claim 11 wherein the cylindrical viewing window comprises a circular front end, a circular rear end, and a viewing window groove located between the circular front end and the circular rear end and extending about a circumference of the cylindrical viewing window and further wherein the gasket is seated in the viewing window groove.

13. The hub sealing cap of claim 1 wherein the cylindrical viewing window comprises a central aperture located approximately in a center of the cylindrical viewing window, and further wherein a plug is mounted to the central aperture of the cylindrical viewing window.

14. The hub sealing cap of claim 13 wherein the plug is a vent plug comprising one or more vent apertures.

15. The hub sealing cap of claim 1 wherein the circular front end of the hubcap body comprises a plurality of apertures separated from each other by a plurality of spokes.

16. The hub sealing cap of claim 15 wherein the hubcap body and the cylindrical viewing window comprise a mating protrusion and recess to ensure the cylindrical viewing window are aligned.

17. The hub sealing cap of claim 1 wherein the cylindrical viewing window is translucent or clear.

18. The hub sealing cap of claim 1 wherein the cylindrical viewing window comprises one or more indicia.

19. The hub sealing cap of claim 1 wherein the circular front end of the hubcap body has a greater diameter than the diameter of the cylindrical viewing window.

20. The hub sealing cap of claim 1 wherein the sidewall of the hubcap body comprises a fill hole removably receiving a fill plug.

21. The hub sealing cap of claim 20 wherein the fill plug is magnetic.

22. The hub sealing cap of claim 20 wherein the fill plug comprises a knurled and/or polygonal-shaped head and a threaded shaft.

23. The hub sealing cap of claim 20 wherein the viewing window retaining ring is located forwardly relative to the fill hole.

24. The hub sealing cap of claim 1 wherein the hub sealing cap holds oil or other lubricant located rearwardly relative to the cylindrical viewing window.

25. The hub sealing cap of claim 1 wherein the sidewall of the hubcap body is not continuous and is comprised of a front segment and a rear segment and further wherein the rear segment is indented relative to the front segment.

26. The hub sealing cap of claim 25 wherein the sidewall groove is located in the front segment.

27. The hub sealing cap of claim 1 wherein the inner face of the sidewall comprises at least a segment between the rear end of the hubcap body and the sidewall groove in which the sidewall interior faces tapers in decreasing diameter.

28. The hub sealing cap of claim 1 wherein the circular front end comprises one or more apertures.

29. A hub sealing cap comprising:
a cylindrical hubcap body comprising a circular front end, a circular rear end, and a sidewall located between the circular front end and the circular rear end, the sidewall comprising a sidewall interior face and a sidewall exterior face, and a hollow interior, the sidewall interior face facing the hollow interior;
a cylindrical viewing window located in the hollow interior, confronting the sidewall interior face, the cylindrical viewing window clear or translucent, the cylindrical viewing window comprising a front end and a rear end; and
a viewing window retaining ring located to the rear of the cylindrical viewing window front end and preventing the cylindrical viewing window from moving rearwardly in the hollow interior.
